(19) United States
(12) Patent Application Publication
(10) Pub. No.: US 2010/0061794 A1
(43) Pub. Date: Mar. 11, 2010

(54) ADJUSTABLE FASTENING STRAP

(76) Inventor: FLOYD H. M. SAM, Newburgh, NY (US)

Correspondence Address: James Ray & Associates, 2640 Pitcairn Road, Monroeville, PA, 15146, US

(21) Appl. No.: 12/554,048

(22) Filed: Sep. 4, 2009

Related U.S. Application Data
(60) Provisional application No. 61/095,404, filed on Sep. 9, 2008.

(51) Int. Cl. B42F 13/06; B65D 63/00

(52) U.S. Cl. 402/8; 24/19

(57) ABSTRACT

A releasable adjustable binding apparatus includes an elongated substantially flexible strap having a top surface, a bottom surface, and two free ends with a first saw-tooth portion along the top surface proximal one free end; and, a loop fixedly attached proximal a second free end traversing the top surface with a gap between the loop and the top surface. A substantially flexible nose piece is attached to the loop with a second saw-tooth portion engageable with the first saw tooth portion and on a side adjacent the top surface, and at least one moveable loop slidingly connected to the elongated strap between the stationary loop and the first saw tooth portion.

### CROSS REFERENCE TO RELATED APPLICATION

This patent application is related to and claims priority from U.S. Provisional Patent Application Ser. No. 61/095,404 filed Sep. 9, 2008.

### FIELD OF THE INVENTION

The present invention relates, in general, to adjustable-length straps and, more particularly, this invention relates to a readily-releasable and adjustable toothed prong fastener.

### BACKGROUND OF THE INVENTION

Prior to the conception and development of the present invention, stacks of papers and other items have been bound together with a variety of releasable means. Most common for papers are thin metal dual-prong fasteners which can have some sharp edges, and the loops that side over them tend to keep slipping off. Plastic prong fasteners have been in commercial use for some time, but they do not bend or stay flat as readily as the metal prong ones. Another common type of plastic fastener is the cable tie, which can tightly bundle together items, but once locked shut, they must be cut to release. Flexible plastic watch bands have been in use for many years, but bending around the buckle eventually causes a fatigue failure. Hence, there is still a need for a user-friendly releasable plastic fastener applicable to this and many uses.

One example of a prong-type paper fastener in the prior art is taught by Corey in U.S. Pat. No. 5,059,051. Another is disclosed by Noguchi in U.S. Pat. No. 5,385,419. Plastic prong fasteners with teeth are taught by Bennett et al in U.S. Pat. No. 5,257,870 and by Swift et al in U.S. Pat. No. 5,626,432. Neither discloses any sliding loops to help retain the prong members in place.

### SUMMARY OF THE INVENTION

The present invention provides a releasable adjustable binding apparatus including an elongated substantially flexible strap having a top surface, a bottom surface, and two free ends with a first saw-tooth portion along the top surface proximal one free end; and, a stationary loop fixedly attached proximal a second free end traversing the top surface with a gap between the loop and the top surface. A substantially flexible nose piece with a second saw-tooth portion engageable with the first saw tooth portion is attached to the stationary loop with the teeth on a side adjacent the top surface. At least one moveable loop is slidingly connected to the elongated strap between the stationary loop and the first free end.

In an alternative embodiment of the present invention, the binding apparatus comes in two parts for the purpose of binding together pre-punched papers in a manner that permits addition of more papers over a wide stack height. In this embodiment, one part is an elongated planar bar member having stationary loops with attached nose pieces adjacent each end, and also an aperture proximal each end. The second part is an elongated strap with teeth covering a portion of an outward side adjacent each end. The ends of the elongated strap are threaded through a stack of papers, then the apertures, and then the stationary loops and finally locking temporarily with the teeth under the nose piece.

### OBJECTS OF THE INVENTION

It is, therefore, one of the primary objects of the present invention to provide an adjustable-length plastic binding apparatus with a convenient lock and release mechanism.

Another object of the present invention is to provide an improved adjustable plastic prong paper binder with a more secure manner of locking.

Still another object of the present invention is to provide a plastic prong paper fastener with improved safety and functionality compared to conventional metal prong fasteners.

Yet another object of the present invention is to provide a plastic fastener apparatus which can tightly secure a wide range of stack sizes in a readily releasable manner.

An additional object of the present invention is to provide an improved adjustable strap system for a variety of items such as baseball caps, book bags, and wristwatches.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective detail view of the adjustable lock and release means of the straps in the present invention.

FIG. 2 provides a side perspective close up detail view of the releasable strap.

FIG. 3 is a perspective view of an application of the present invention in a paper binding apparatus.

FIG. 4 provides a perspective view of a general adjustable strap embodiment of the present invention in an open position.

FIG. 5 provides a perspective view of a general adjustable strap embodiment of the present invention in a closed position.

FIG. 6 provides a perspective view of an alternative application of the present invention.

FIG. 7 provides a perspective view of an alternative embodiment of a paper binding apparatus.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

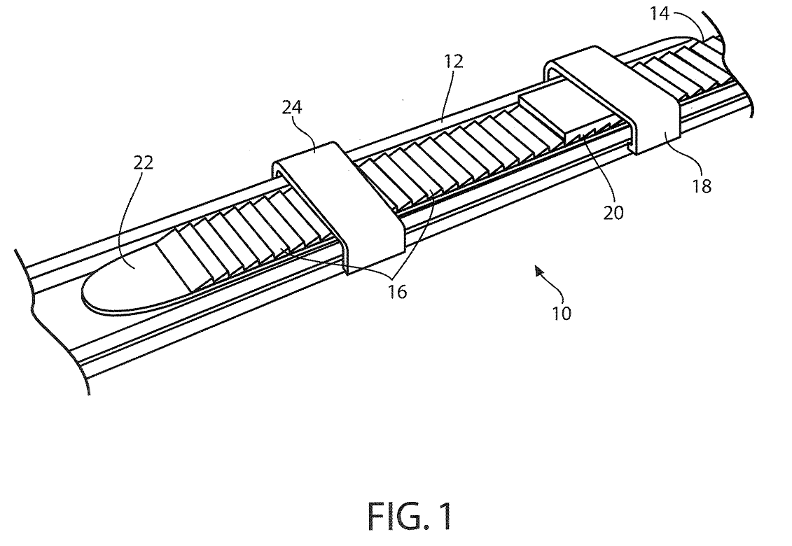

Referring initially to FIG. 1, which is a perspective view of the adjustable lock and release means of the strap in the present invention, the adjustment and locking means 10 are shown in substantial detail. The elongated strap 12 preferably forms a low-profile channel at a first end slightly wider than the substantially flexible prong second end 14, which has a portion of the top surface covered with teeth 16 in a saw-tooth pattern starting adjacent the free end 22 and extending a length typically between about two and ten inches. The elongated strap 12 may be either substantially rigid or, preferably, a substantially flexible plastic, and can optionally be flat as opposed to forming a channel as shown. Removed somewhat from the first free end of the elongated strap 12 is a stationary loop 18 fixedly connected to the sides and/or bottom surface of the first end of strap 12 with a gap between the stationary loop 18 and the top surface of strap 12. Attached adjacent one top-side edge of this fixedly attached stationary loop 18 is a substantially flexible nose 20, which has teeth engageable with the teeth 16 on the flexible prong 14. The free end of the flexible prong 22 is slid under the stationary loop 18 and past the nose 20. Backsliding of the toothed prong 14 is restricted by the reverse saw-pattern teeth on the underside of the nose 20 until deliberate release is desired, at which time the flexible nose 20 is lifted far enough to disengage the teeth and allow the prong end 22 to be pulled back or out. The stationary band 18 and the flexible nose 20 are two key features that differentiate the present invention from commercial prong-type binders and other prior art. At least one moveable loop 24 is slidingly engaged with the edges of the first end of strap 12 for holding down the end of the toothed prong 14 near the free end 22.

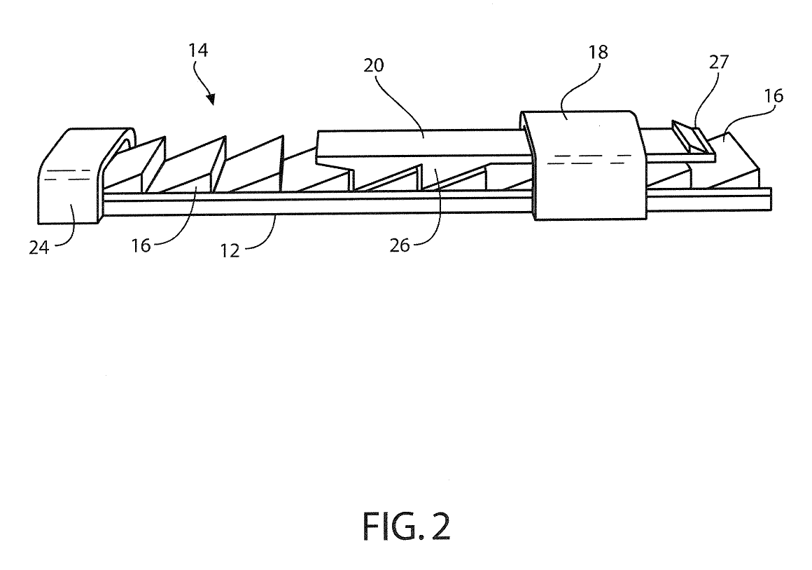

FIG. 2 provides a side perspective close up detail view of the releasable strap of the present invention. A portion of the flexible prong 14 is covered with saw-pattern teeth 16 and is resting on top of the strap 12 after being threaded through the stationary loop 18 and beyond the substantially flexible nose 20. Teeth 26, in a saw-tooth pattern reverse of teeth 16, on the underside of the nose 20 engage with the teeth 16 on the top side of the prong 14 such that the flexible toothed end 14 cannot travel in the reverse direction until the nose 20 is lifted enough to disengage the teeth 26 from the teeth 16. The nose 20 is attached to the stationary loop 18 in any one of several ways, permanent or replaceable, a replaceable option indicated by the tooth tip 27 which has been slid through a slot on the underside of loop 18. Other acceptable attachment means would be rivets, screw, and adhesives. Another option is all one molded piece. The flexible nose 20 and the moveable band 24 may alternatively be located to the right of the stationary band 18. Another alternative is to have two sliding loops 24, one to hold down the nose 20 and another to hold down the strap end 22.

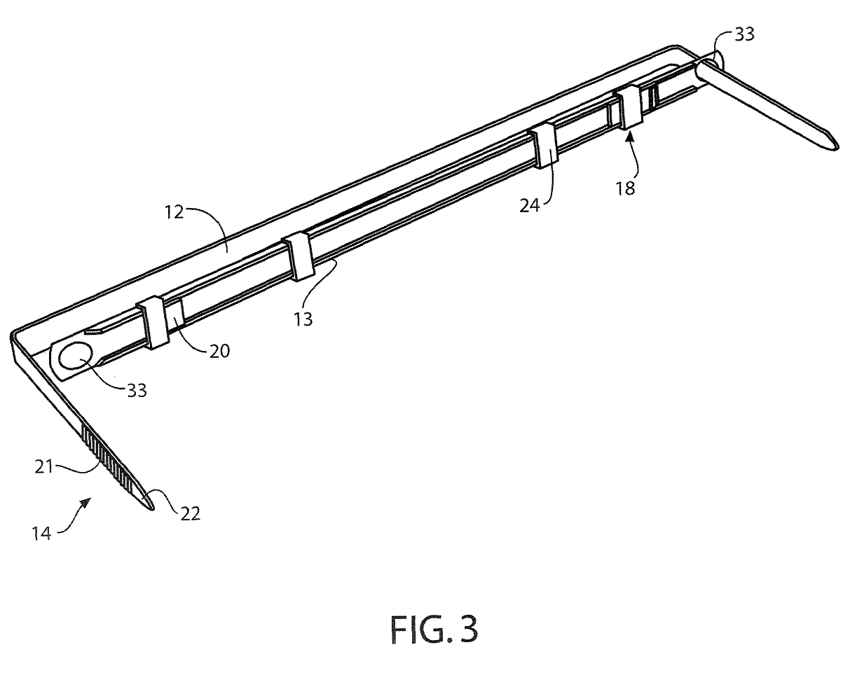

FIG. 3 is a perspective view of an application of the present invention in a paper binding apparatus. For this application, the bar member 13 is a piece separate from the elongated planar bendable strap 12, which will have a toothed section 14 on one or both sides adjacent the free ends of the prong member 22. The bar member 13 typically is substantially rigid, but may have varying degrees of flexibility. Both the bar member 13 and elongated strap 12 are preferably made from a pigmented plastic. The ends of the bar member 13 will typically have apertures 33 so as to align closely with holes punched in the stack of papers which are to be bound together. After the ends 22 of prong 21 are fed through holes in a stack of paper and the apertures 33 in the bar member 13, they are then bent inward and threaded through the stationary loops 18 and under the flexible nose pieces 20, and then the movable loops 24 are slid past the tips of the free ends 22 to hold the prongs 21 down relatively flat.

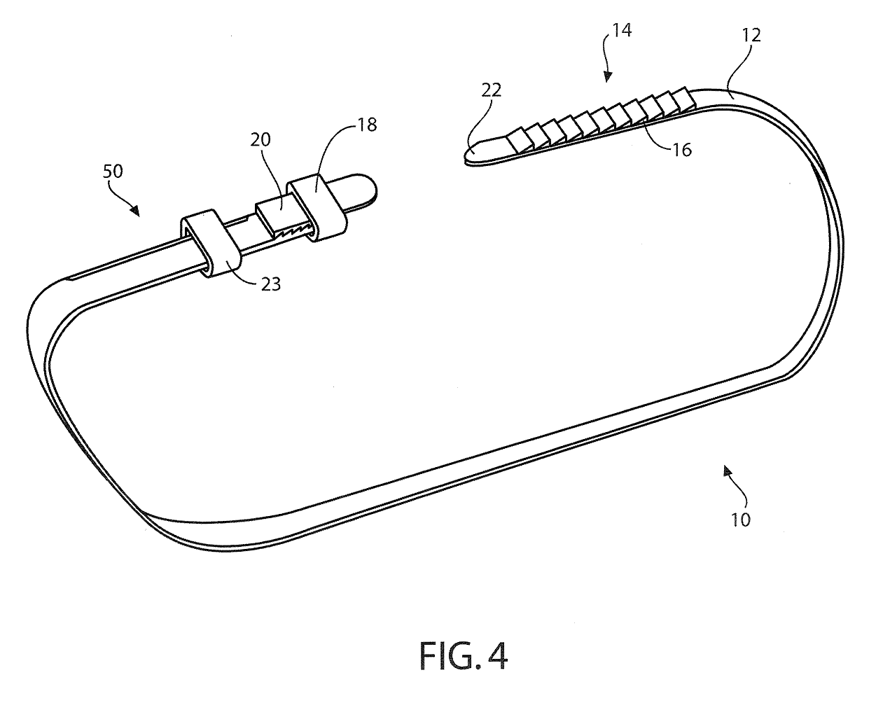

FIG. 4 is a perspective view of a general strap arrangement 10 of the present invention in an open position. The elongated flexible band 12 has a toothed portion 14 ending at a first free end 22 and a substantially smooth portion 50 which ends proximal the fixedly attached stationary loop 18. The portions 14 and 50 can alternatively be reversed as to which is on the left and which is on the right. A less preferred variation would be to have both the toothed portion 14 and the smooth portion 50 on reverse sides of the elongated strap 12. The toothed section 14 has saw-pattern teeth 16 that permit movement into the stationary loop to the left, but will catch on reverse teeth in the nose piece 20 if movement is reversed. The tip of free end 22 can be slid under the stationary band 18 on the second free end 50, and then under the nose piece 20. Once at the desired position for tightness, the moveable loop 23 slides over top to hold down the free end 22 or the nose piece 20.

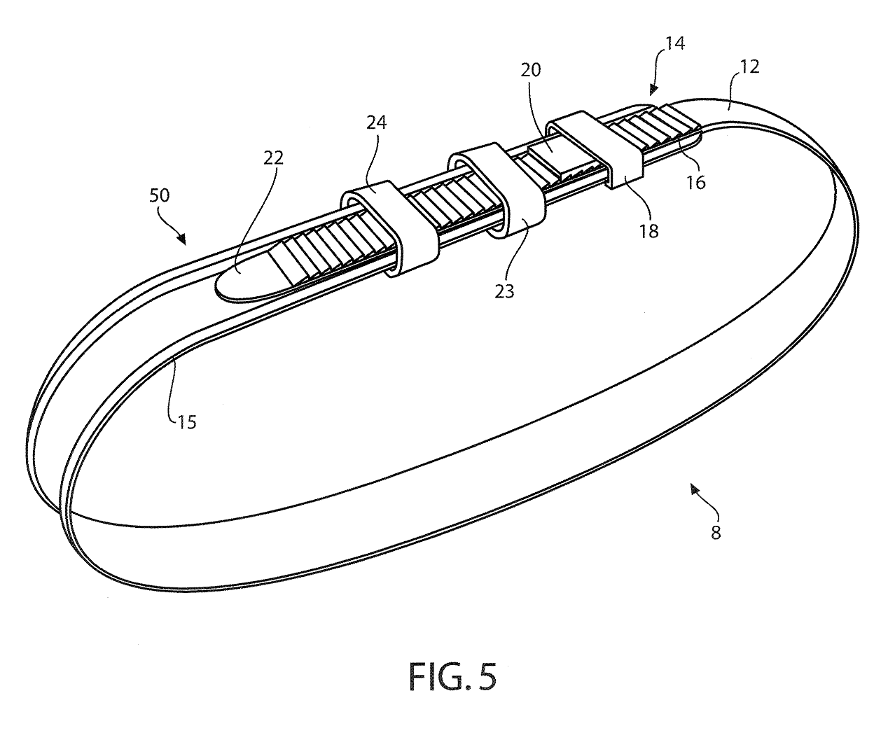

FIG. 5 provides a perspective view of a general adjustable strap embodiment 8 of the present invention. The elongated flexible band 12 has a toothed portion 14 ending at a first free end 22 and a substantially smooth portion 50 which ends proximal the stationary loop 18. After wrapping the strap 8 around items to be bundled, the tip 22 of the toothed portion 14 is treaded first through the stationary loop 18 and its nose 20, which are fixed adjacent the free end of the smooth zone 50. Then, the tip 22 is fed through a first movable loop 23 and preferably through a second movable loop 24. The movable loops 23 and 24 are slidingly engaged with the edges of the smooth portion 50 of the band 12. The tip end 22 is pulled while holding the stationary loop 18 until the adjustable strap 8 is tight around the items. Preferably, the first movable loop 23 is then slid over the nose 20 to secure it down in the locked position. To release, the first movable loop 23 is slid away from the nose 20, and the flexible nose 20 is then lifted slightly manually to disengage the teeth on the underside of the nose 20. The two ends of the elongated strap 8 can then be separated.

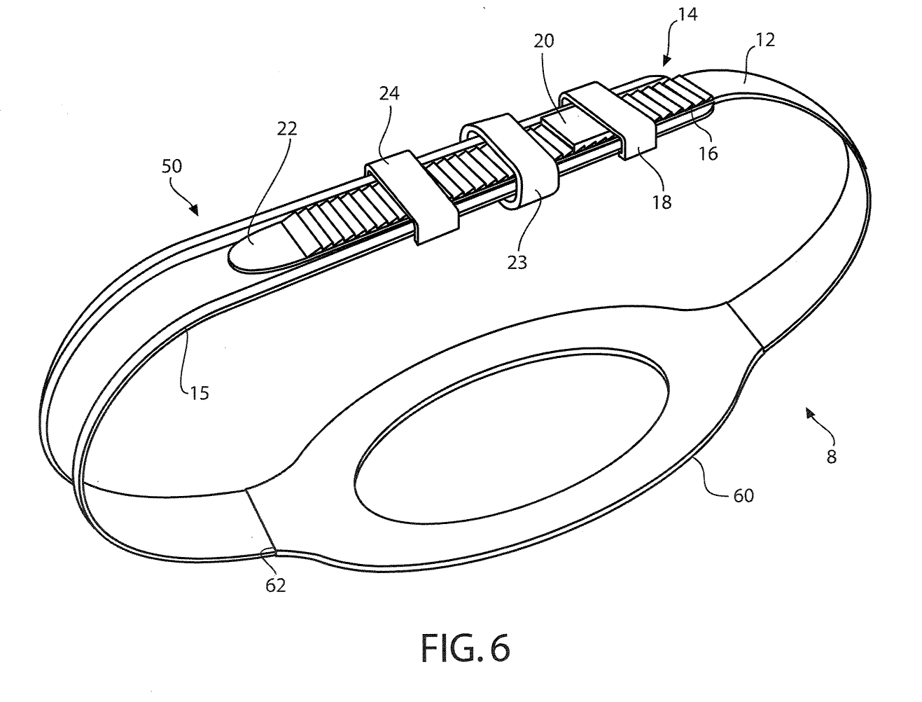

FIG. 6 provides a perspective view of an alternative application of the present invention that is much like that shown in FIG. 5. In this example, the elongated strap 12 has been split near the center into two ends which are attached to strap connections 62 on a wristwatch 60.

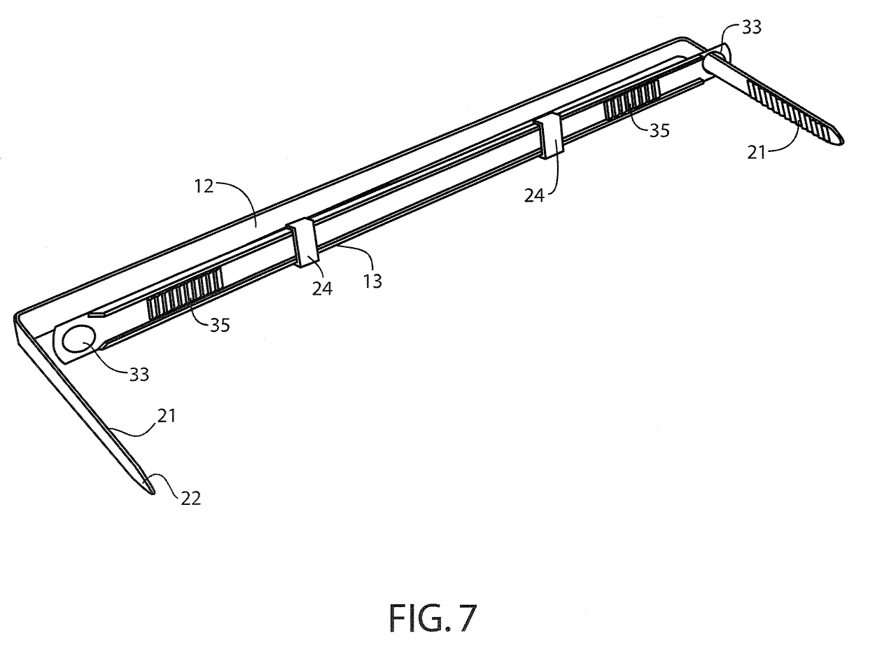

FIG. 7 provides a perspective view of an alternative embodiment of a paper binding apparatus. The bar member 13 is a piece separate from the elongated planar bendable strap 12, the strap having a first toothed portion 21 on an inward side adjacent each of the free ends 22 of the elongated strap 12. Each first toothed portion typically with extend for about two to ten inches. The bar member 13 typically is substantially rigid, but may have varying degrees of flexibility, and it has saw-like teeth 35 along most of the first top side of the bar 13. The ends of the bar member 13 will typically have apertures 33 placed so as to align closely with holes punched in the stack of papers which are to be bound together. After the prong ends 22 of the toothed area 21 are fed through holes in a stack of paper and the apertures 33 in the bar member 13, they are then bent inward and threaded under moveable loops 24 to hold the prong ends 22 down relatively flat.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

I claim:

1. A releasable adjustable binding apparatus comprising:
a) an elongated substantially flexible strap having a top surface, a bottom surface, a first free end and a second free end;
b) a first saw-tooth portion along a predetermined length of said top surface of one of said first free end and said second free end;
c) a loop fixedly attached proximal an opposed one of said first and said second free end traversing said top surface with a gap between said loop and said top surface; and
d) a substantially flexible nose piece attached to said loop with a second saw-tooth portion engageable with said first saw tooth portion and on a side adjacent said top surface.

2. The adjustable binding apparatus, according to claim 1, wherein at least one moveable loop is slidingly connected to said elongated strap between said loop and said first saw-tooth portion.

3. The adjustable binding apparatus, according to claim 1, wherein said predetermined length of said first saw-tooth portion is between about two and ten inches.

4. A releasable adjustable binding apparatus for hole-punched papers comprising:
a) an elongated substantially flexible strap having a first top surface, a first bottom surface, a first free prong end and a second free prong end;
b) a first saw-tooth portion along a predetermined length of said first top surface of said first free prong end and said second free prong end;
c) an elongated planar bar member having a second top surface and a second bottom surface and a third end and a fourth end with apertures adjacent said third and fourth ends;
d) loops fixedly attached proximal said third and fourth free ends and traversing said second top surface with a gap between said loop and said second top surface; and
e) a substantially flexible nose piece attached to said loops with a second saw-tooth portion on a side of said nose piece adjacent said second top surface.

5. The adjustable binding apparatus, according to claim 4, wherein said at least one moveable loop is slidingly connected to said elongated bar member between said loops.

6. The adjustable binding apparatus, according to claim 4, wherein said predetermined length of said first saw-tooth portion is between about two and ten inches.

7. A releasable adjustable binding apparatus for hole-punched papers comprising:
a) an elongated planar bar member having a first top surface and a first bottom surface and a first end and a second end with apertures disposed through said bar member adjacent said first and second ends, said first top surface having a first saw-tooth portion disposed along substantially all of said first top surface;
b) an elongated substantially flexible strap, said strap having a pair of end portions, each of said end portions including a second saw-tooth portion for engaging said first saw tooth portion of said bar member and each of said pair of end portions disposed through a respective one of said apertures; and
c) at least two moveable loops slidingly attached to said elongated bar member and traversing said first top surface with a gap between said moveable loops and said first top surface, said movable loops slidingly engaging a top surface of each respective one of said end portions for maintaining engagement of said first and second saw-tooth portions.
